(19) United States
(12) Patent Application Publication
(10) Pub. No.: US 2006/0279060 A1
(43) Pub. Date: Dec. 14, 2006

(54) Structure of a locking device for a fork of a cart for use by elderly and handicapped persons

(76) Inventors: Hui-Pin Yang, Chiayi City (TW); Chen-Chi Hsiao, Dalin Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/151,413

(22) Filed: Jun. 14, 2005

(51) Int. Cl. B62K 21/00

(52) U.S. Cl. 280/279

(57) ABSTRACT

A cart includes a frame, an actuating mechanism, a fork, two handlebars, and a pin used for making the actuating mechanism activated; the frame having a head tube secured at a front end; the fork is passed through the head tube at an upper straight rod portion such that it can be angularly displaced; a front wheel is supported with two opposing lower tail ends of the fork; a first plate, which has a hole, is secured on a front of the head tube; a second plate, which has a hole, is secured on a front of the fork, near to the first plate; the holes will face each other when the front wheel is in the forward direction; after the pin is passed through the holes of the plates, it will be held in position to prevent the fork from moving relative to the head tube.

### BACKGROUND OF THE INVENTION

1. Field of the Invention

The present invention relates to a locking device for a fork of a cart for use by the elderly and handicapped persons, more particularly one, which has a simply-structured locking mechanism for preventing handlebars and fork assembly from moving when the cart isn't in use.

2. Brief Description of the Prior Art

The most common carts for use by handicapped and elderly persons are three-wheeled because three-wheeled carts have simpler structure and lower manufacturing cost than four-wheeled ones, and they are as easy to control as four-wheeled ones for the elderly. A common three-wheeled cart includes a frame, a seat, a head tube secured to the frame, a foldable fork passed through and angularly displaceable relative to the head tube, a front wheel connected to opposing lower tail ends of the fork, a pair of handlebars joined to an upper end of the fork, two rear wheels, a motor connected to the rear wheels, and storage batteries electrically connected to the motor.

The cart will occupy less space, and can be put into the trunk of a car, and transported after the seat is separated from the frame, and the fork folded. Furthermore, a locking mechanism is used to prevent the fork from moving relative to the head tube when the cart is transported. Conventional locking mechanisms of carts have relatively complicated structure, and manufacturing cost of the carts increases accordingly.

### SUMMARY OF THE INVENTION

It is a main object of the invention to provide an improvement on a locking device for a fork of a cart for use by handicapped persons and the elderly to overcome the above-mentioned problem. The locking device includes first and second plates, and a pin. The frame of the cart has a head tube secured at a front end. A fork, which has two handlebars at an upper end, is passed through the head tube at an upper straight rod portion so as to be angularly displaceable. A front wheel is supported with two opposing lower tail ends of the fork. The first plate has a hole, and is secured on a front of the head tube. The second plate has a hole, and is secured on a front of the fork, near to the first plate. The holes of the first and the second plates will face each other exactly when the front wheel is in the forward direction. The pin will be stay in the holes of the plates to prevent the fork from moving relative to the head tube after being passed through the holes of the plates.

### BRIEF DESCRIPTION OF THE DRAWINGS

The present invention will be better understood by referring to the accompanying drawings, wherein:

FIG. 1 is a side view of the cart according to the present invention,

FIG. 2 is a partial perspective view of the cart of the invention,

FIG. 3 is a side view of the cart of the invention, with the fork being locked with the locking mechanism, and

FIG. 4 is a partial perspective view of the cart of the invention.

### DETAILED DESCRIPTION OF THE PREFERRED EMBODIMENTS

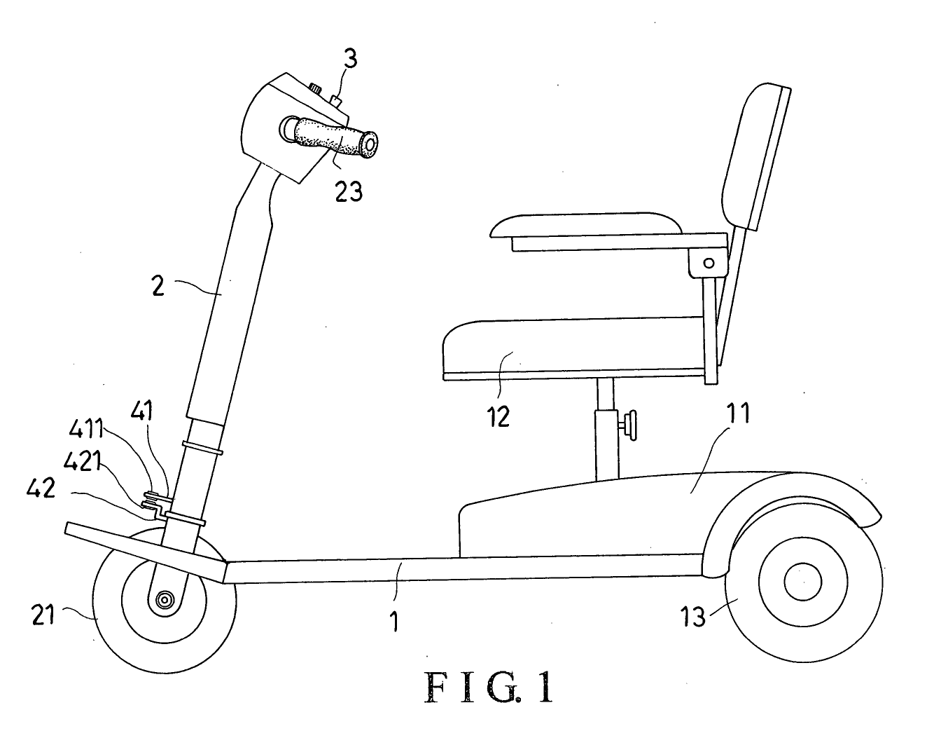

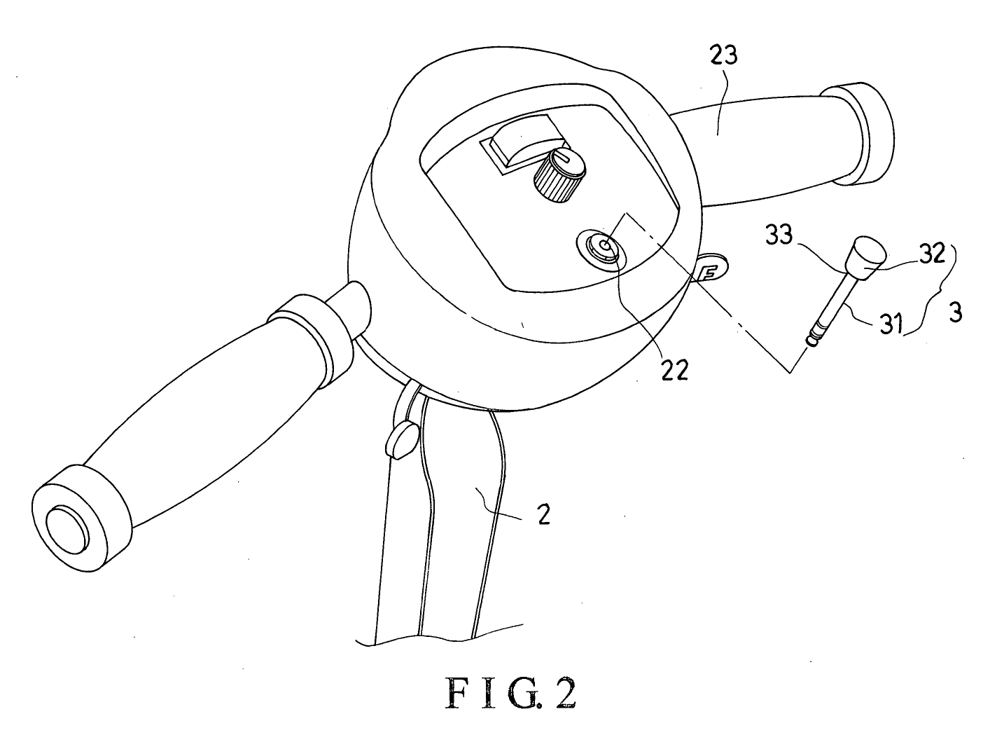

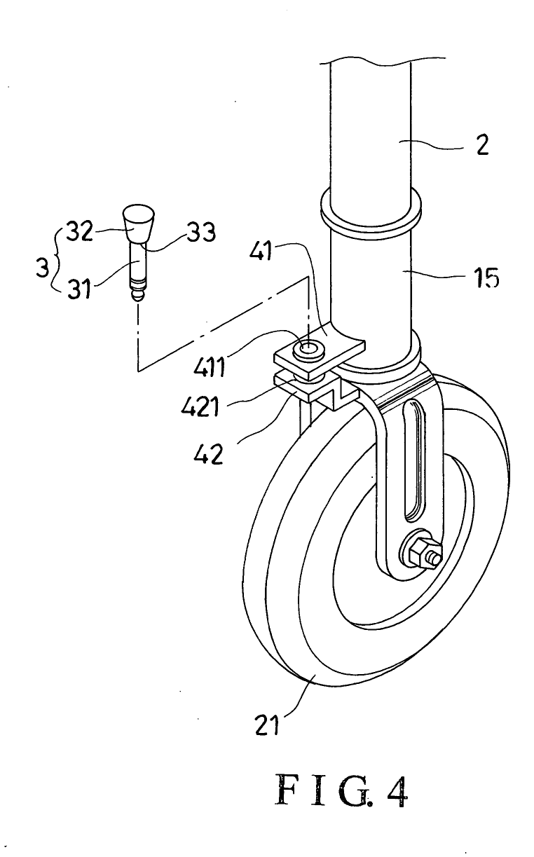

Referring to FIGS. 1 to 4, a preferred embodiment of a cart for use by the elderly and handicapped persons includes a frame 1, an actuating mechanism 11, a seat 12, a fork 2, a front wheel 21, two rear wheels 13, a pair of handlebars 23, a pin 3, a control panel, and first and second plates 41 and 42.

The frame 1 has a head tube 15 secured at a front end thereof. Both the actuating mechanism 11 and the seat 12 are supported on the frame 1. The rear wheels 13 are supported on two sides of a rear portion of the frame 1, and connected to the actuating mechanism 11 such that they will turn when the actuating mechanism 11 is activated.

The fork 2 is passed through the head tube 15 at an upper straight rod portion thereof such that it can be angularly displaced relative to the head tube 15. Furthermore, the upper straight rod portion of the fork 2 can be folded. The front wheel 21 is positioned between and supported with two lower tail ends of the fork 2 which are a distance apart.

The first plate 41 is formed with a through hole 411, and securely joined to a front side of the head tube 15. The second plate 42 is formed with a through hole 421, and securely joined to a front side of the fork 2 under the first plate 41. Therefore, the through hole 421 will face the through hole 411 exactly when the front wheel 21 is in the forward direction.

The pin 3 has an insertion portion 31, a handle portion 32 having a greater width than the insertion portion 31, and a step-shaped portion 33 between the insertion portion 31 and the handle portion 32. The control panel is securely joined to an upper end of the fork 2, and it has a hole 22 thereon. The handlebars 23 are securely joined to two sides of the control panel. In the present embodiment, the actuating mechanism 11 is powered with electricity. Alternatively, a fuel-powered actuating mechanism can be used. The actuating mechanism 11 is activated by means of inserting the pin 3 into the hole 22 on the control panel. In another embodiment of the present invention, the pin 3 is in the shape of a key, and the actuating mechanism 11 is activated by means of inserting the pin 3 into the hole 22 and then turning the pin 3.

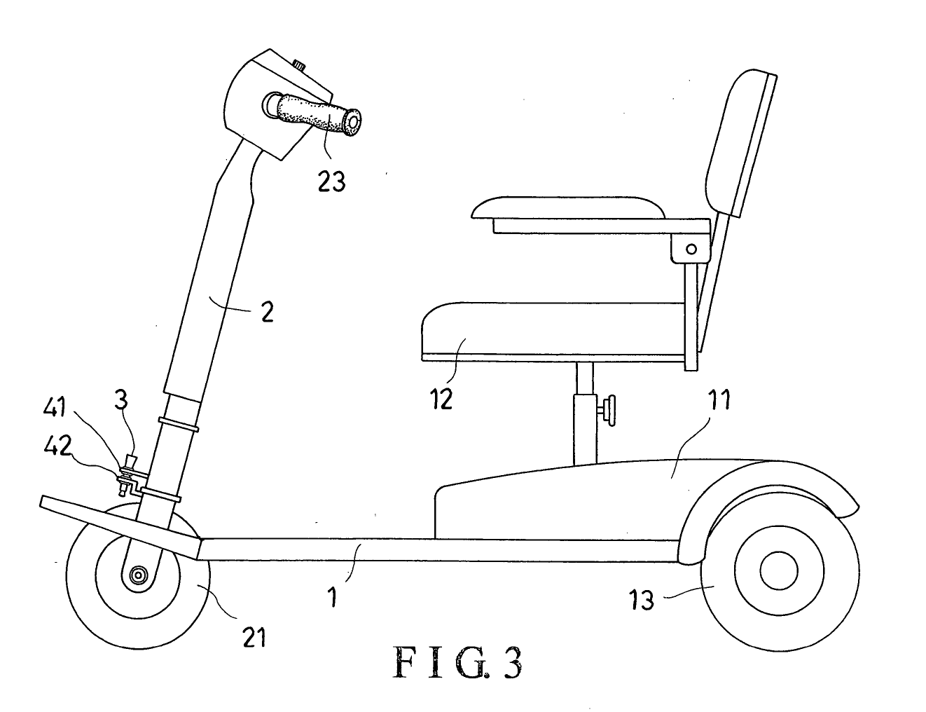

Therefore, when the cart is not in use, a person is allowed to lock the fork 2 and the handlebars 23 by means of passing the pin 3 through the through holes 411 and 421 of the first and the second plates 41 and 42, as shown in FIG. 3; thus, the handle portion 32 of the pin 3 will rest on the first plate 41, and the fork 2 and the handlebars 23 can't move relative to the head tube 15. Furthermore, a person is allowed to reduce the size of the cart by means of folding the upper straight rod portion of the fork 2.

From the above description, it can be easily seen that the present invention has the following advantages:

1. The locking mechanism for the fork has a relatively simple structure, only consisting of the first and the second plates and the pin. And, the locking mechanism is easy to use.

2. The cart of the present invention has lower manufacturing cost than others, and is competitive and suitable for mass production because the locking mechanism has a much simpler structure than those of conventional carts.

What is claimed is:

1. A cart for use by the elderly and handicapped persons, comprising
a frame;
an actuating mechanism supported on the frame;
a fork; the fork being supported on a front end of the frame in an angularly displaceable manner;
a front wheel positioned between and supported with two lower tail ends of the fork which are a distance apart;
a first plate formed with a through hole; the first plate being securely joined to a front end of the frame;
a second plate formed with a through hole; the second plate being securely joined to a front side of the fork, near to the first plate; the through hole of the second plate being going to face the through hole of the first plate exactly when the front wheel is in a forward direction; and
a pin used for making the actuating mechanism activated; the pin being going to stay in the through holes of the first and the second plates so as to prevent the fork from moving relative to the frame after being passed through both the through holes.

2. The cart as claimed in claim 1 further having a hole formed thereon; the actuating mechanism being going to be activated as soon as the pin is inserted in the hole.

3. The cart as claimed in claim 1 further having a hole formed thereon; the actuating mechanism being going to be activated as soon as the pin is inserted, and turned in the hole.
